(19) United States
(12) Patent Application Publication
(10) Pub. No.: US 2013/0175434 A1
(43) Pub. Date: Jul. 11, 2013

(54) INDICATOR TESTING SYSTEM

(71) Applicants: WEI-HSIANG HUANG, NEW TAIPEI CITY (TW); CHENG-HUNG WU, NEW TAIPEI CITY (TW); CHING-FENG HSIEH, TAIPEI CITY (TW)

(72) Inventors: WEI-HSIANG HUANG, NEW TAIPEI CITY (TW); CHENG-HUNG WU, NEW TAIPEI CITY (TW); CHING-FENG HSIEH, TAIPEI CITY (TW)

(73) Assignees: ASKEY COMPUTER CORP.; ASKEY TECHNOLOGY (JIANGSU) LTD.

(21) Appl. No.: 13/432,474

(22) Filed: Mar. 28, 2012

(30) Foreign Application Priority Data
Jan. 10, 2012 (TW) 101100988

(51) Int. Cl. G01J 1/42

(52) U.S. Cl. 250/208.2

(57) ABSTRACT

An indicator testing system for testing a plurality of indicators disposed on an electronic product and adapted to display a status includes a plurality of light sensors, a holder for holding the light sensors, and a signal processing module. The light sensors correspond in position to the indicators on the electronic product, respectively, and each generate a corresponding light testing signal whereby the signal processing module generates a brightness testing signal related to each indicator. The indicator testing system speeds up an indicator test, enhances the precision of the indicator test, and ensures the quality of the electronic product.

### CROSS-REFERENCE TO RELATED APPLICATION

This non-provisional application claims priority under 35 U.S.C. §119(a) on Patent Application No(s). 101100988 filed in Taiwan, R.O.C. on Jan. 10, 2012, the entire contents of which are hereby incorporated by reference.

### FIELD OF TECHNOLOGY

The present invention relates to indicator testing systems, and more particularly, to a testing system for testing a plurality of indicators disposed on an electronic product and adapted to display a functional status.

### BACKGROUND

Due to advancement of the electronic industry, a wide variety of electronic devices, such as computer equipment and network communication equipment are manufactured by mass production. The electronic products are usually equipped with indicators for displaying current statuses of the electronic products. At a production line, the indicators are useful in reading and determining whether the electronic products are functioning well or malfunctioning. Hence, the operation of the indicators is one of the factors in ensuring product quality.

According to the prior art, operation workers at a production line usually inspect the indicators with the naked eye to determine whether the indicators are on in order to confirm whether the indicators are functioning well (for example, whether the indicators emit light normally, and whether the light emitted by the indicators is of sufficient intensity.) Hence, inspecting the indicators with the naked eye is not only time-consuming but also susceptible to man-made errors to the detriment of product quality.

### SUMMARY

It is an objective of the present invention to provide precise results of an indicator-based test.

Another objective of the present invention is to cut manpower and costs and ensure product quality.

In order to achieve the above and other objectives, the present invention provides an indicator testing system for testing a plurality of indicators disposed on an electronic product and adapted to display a status, comprising: a plurality of light sensors corresponding in position to the indicators, respectively, for sensing optical signals from the indicators and generating light testing signals based on the optical signals, respectively; a holder for holding the light sensors to allow the light sensors to correspond in position to the indicators on the electronic product, respectively; and a signal processing module connected to the light sensors for receiving the light testing signals from the light sensors and generating brightness testing signals of the indicators based on the light testing signals, respectively.

In an embodiment, the light sensors each comprise: a light-sensing element for sensing the optical signals and generating the light testing signals based on the optical signals, respectively; a mask enclosing the light-sensing element, extending forward, and enclosing a light path between the light-sensing element and a corresponding one of the indicators; and a casing coupled to the light-sensing element and the mask and coupled to the holder.

In an embodiment, the casing is externally provided with a thread for engaging with the holder.

In an embodiment, the indicator testing system further comprises a control unit connected to the signal processing module for receiving the brightness testing signals and determining whether the indicators are normal based on the brightness testing signals, respectively.

In an embodiment, the indicator testing system further comprises a control unit connected to the signal processing module for receiving the brightness testing signals and determining an operation status of the electronic product based on sequence of the brightness testing signals or duration of the brightness testing signals.

Accordingly, the embodiment of the present invention dispenses with the conventional labor-intensive indicator tests but employs a precise testing system in performing a test on indicators so as to speed up the test, avoid man-make errors, and enhance product quality.

### BRIEF DESCRIPTION

Objectives, features, and advantages of the present invention are hereunder illustrated with specific embodiments in conjunction with the accompanying drawings, in which:

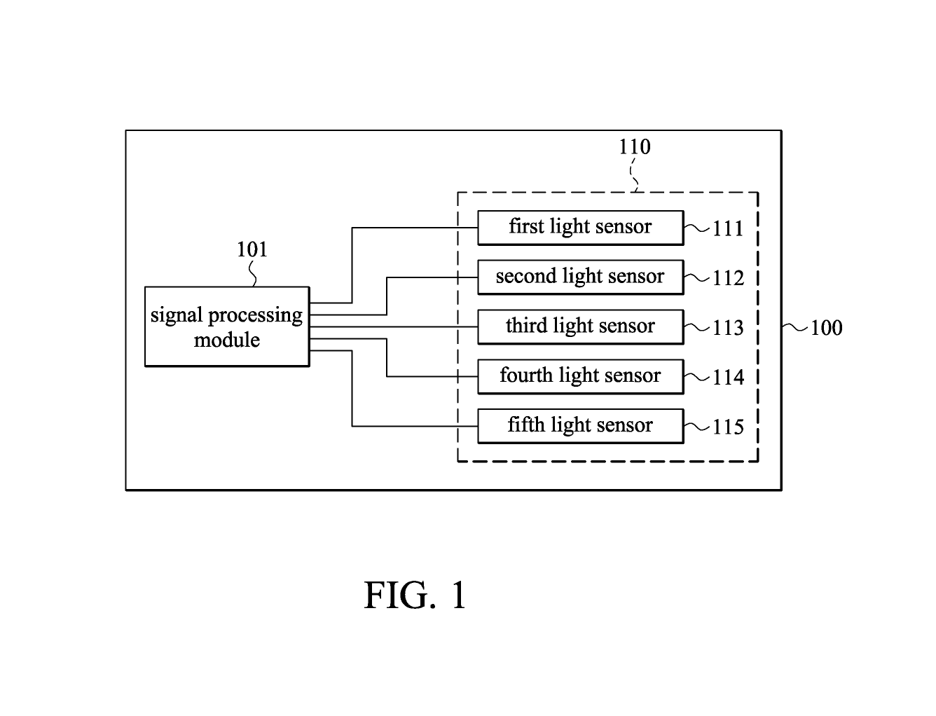

FIG. 1 is a functional block diagram of an indicator testing system according to an embodiment of the present invention;

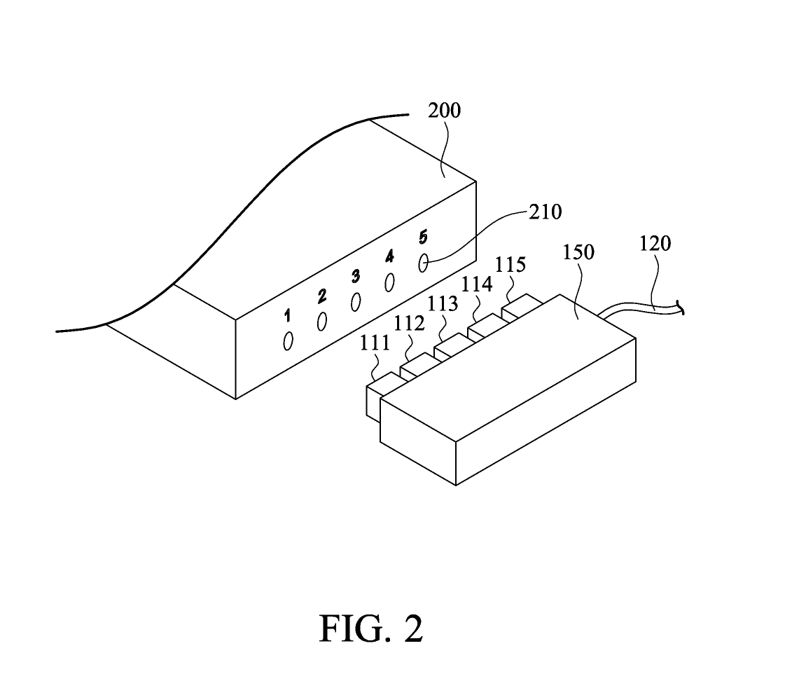

FIG. 2 is a schematic view of the indicator testing system and an electronic product under test according to an embodiment of the present invention;

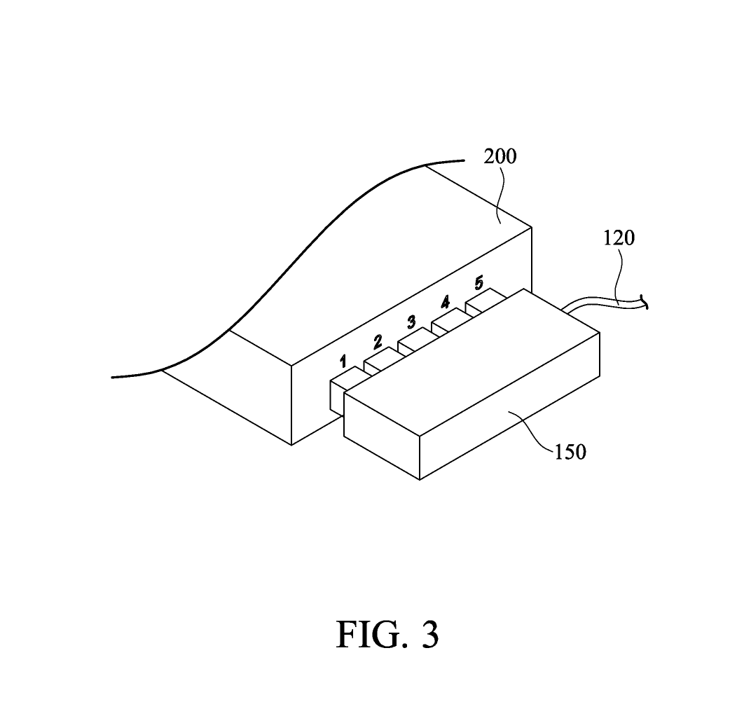

FIG. 3 is a schematic view of the indicator testing system and the electronic product under test according to another embodiment of the present invention;

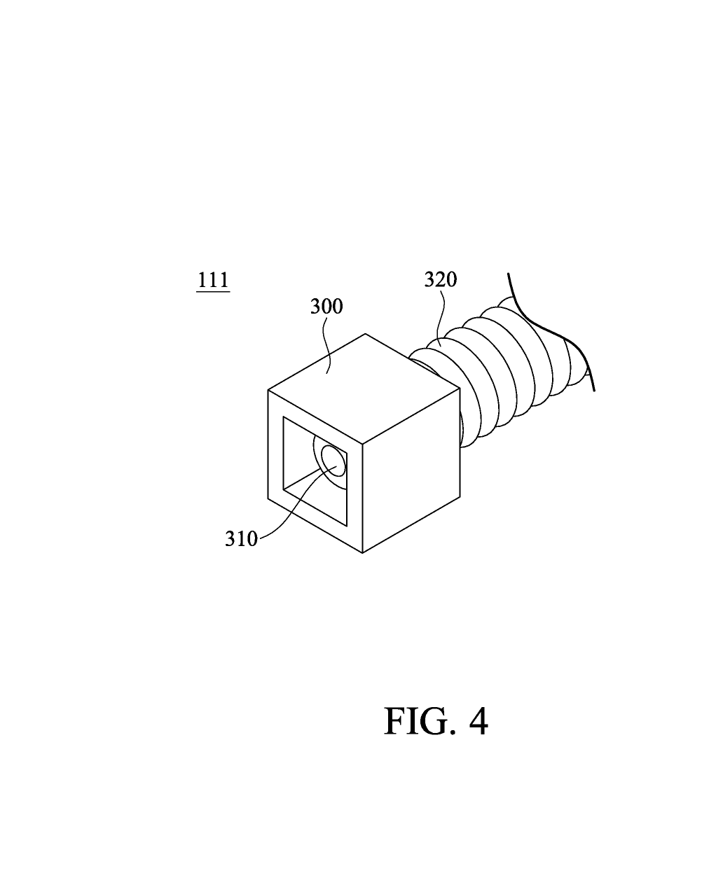

FIG. 4 is a schematic view of light sensors according to another embodiment of the present invention; and

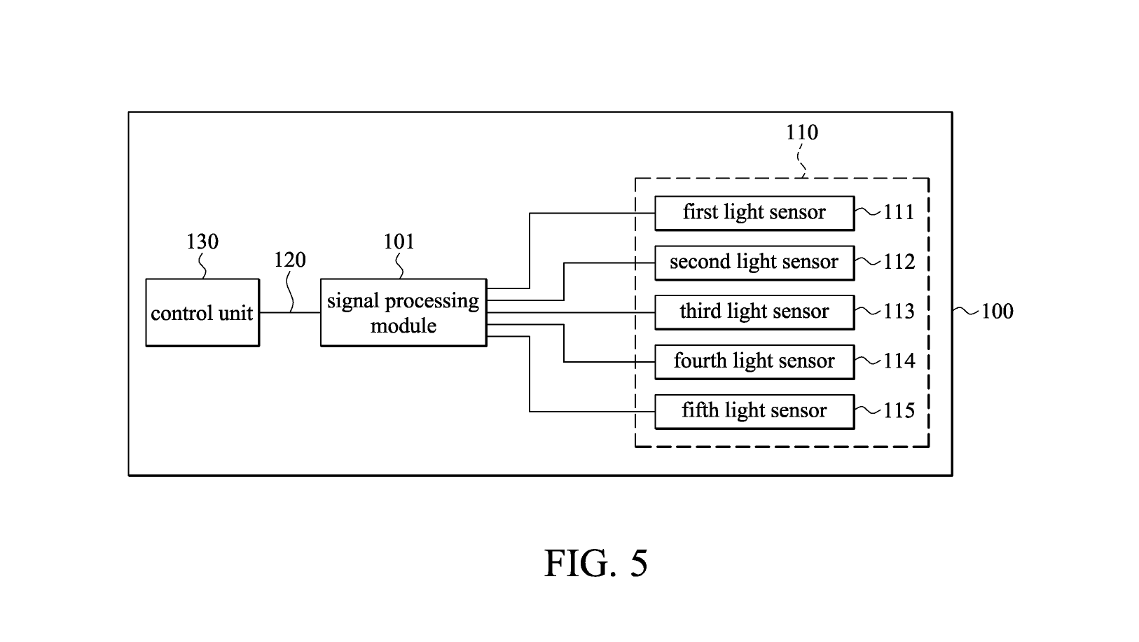

FIG. 5 is a functional block diagram of the indicator testing system according to yet another embodiment of the present invention.

### DETAILED DESCRIPTION

Referring to FIG. 1, there is shown a functional block diagram of an indicator testing system 100 according to an embodiment of the present invention. The indicator testing system 100 comprises a plurality of light sensors 110, a holder 150 (see FIG. 2), and a signal processing module 101. As shown in the drawing, the light sensors 110 are exemplified by five light sensors 111˜115, and the quantity of the light sensors is subject to changes as needed.

The light sensors 110 correspond in position to indicators of an electronic product, respectively, by means of the holder 150, so as to gain insight into the light emission of the indicators. Light emitted from the indicators is perceived by the light sensors as optical signals. If the indicators do not emit any light, there will be no optical signals. The light sensors generate light testing signals according to the optical signals, respectively, for denoting the status and intensity of the light emitted from the indicators.

Signals generated from the light sensors are usually voltage signals. The voltage signals undergo analog-to-digital conversion performed by the signal processing module 101 connected to the light sensors 110, such that the light sensors 110 gain insight into the light emission of the indicators, thereby allowing the signal processing module 101 to generate brightness testing signals of the indicators based on the light testing signals, respectively. Due to the brightness testing signals, a precise test result substitutes for a vision-based test result.

Referring to FIG. 2, there is shown a schematic view of the indicator testing system and an electronic product 200 under test according to an embodiment of the present invention. The electronic product 200 under test is equipped with indicators 210 for indicating the operation status or other statuses of the electronic product 200 under test. As shown in FIG. 2, the five indicators 210 are given the numbers 1, 2, 3, 4, and 5, respectively, and five said light sensors are provided. The first through fifth light sensors 111˜115 are fixed in placed by the holder 150 in a manner that the light sensors correspond in position to the indicators, respectively. The light testing signals generated from the light sensors are transmitted by a signal transmission line 120 to a back-end host computer for recording the light testing signals.

Referring to FIG. 3, there is shown a schematic view of the indicator testing system and the electronic product 200 under test according to another embodiment of the present invention. In a preferred embodiment of the present invention, the light sensors 110 are positioned proximate to the indicators of the electronic product 200 to protect the light sensors 110 against interference from external light so that the test result will not be compromised.

Referring to FIG. 3 and FIG. 4, there is shown in FIG. 4 a schematic view of light sensors according to another embodiment of the present invention. Each of the light sensors of the indicator testing system comprises a light-sensing element 310, a mask 300, and a casing 320.

The light-sensing element 310 senses the optical signals from the indicators and generates the light testing signals based on the optical signals, respectively. The mask 300 encloses the light-sensing element 310, extends forward, and encloses a light path between the light-sensing element 310 and a corresponding one of the indicators.

Referring to FIG. 3, the short distance between the mask 300 and the electronic product 200 is effective in blocking interference from external light. Preferably, the mask 300 is attached to the electronic product 200 so as to enclose completely a light path between the light-sensing element 310 and a corresponding one of the indicators.

The casing 320 is coupled to the light-sensing element 310 and the mask 300. The casing 320 fixes the light-sensing element 310 in place. The mask 300 is fixed to the periphery of the light-sensing element 310 when coupled to the casing 320. In a preferred embodiment, as shown in FIG. 4, the casing 320 is externally provided with a thread for engaging with the holder 150 (see FIG. 2 and FIG. 3.) Despite the aforesaid disclosure, any other connecting means, coupling means, attaching means, and engaging means can be applied to the present invention as appropriate.

Referring to FIG. 5, there is shown a functional block diagram of the indicator testing system according to yet another embodiment of the present invention. As shown in FIG. 5, the light testing signal is transmitted by the signal transmission line 120 to a control unit 130 of a back-end host computer for recording the light testing signal. The control unit 130 is connected to the signal processing module 101 for receiving the brightness testing signals. The control unit 130 determines whether the indicators are normal based on the brightness testing signals, respectively. For example, it is feasible to set an electronic device in such a way that all the indicators are on and/or off for the indicator testing system to test and determine whether the indicators are normal.

The control unit 130 further determines an operation status of the electronic product based on sequence of the brightness testing signals and/or duration of the brightness testing signals. For example, after the electronic product is turned on (i.e., at the point in time when a power indicator lights up) and a preset period of time has passed, the electronic product has to enter a specific operation status (and, in response thereto, a specific operation status indicator has to light up.) The variation in the brightness of the indicators is assessed against preset criteria so as to determine whether the electronic device has broken down. Hence, in the embodiments of the present invention, not only are indicators tested, but the operation of the electronic device is also tested.

In conclusion, the embodiment of the present invention dispenses with the conventional labor-intensive indicator tests but employs a precise testing system in performing a test on indicators so as to speed up the test, avoid man-make errors, and enhance product assurance and product yield of a production line.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. An indicator testing system for testing a plurality of indicators disposed on an electronic product and adapted to display a status, comprising:
a plurality of light sensors corresponding in position to the indicators, respectively, for sensing optical signals from the indicators and generating light testing signals based on the optical signals, respectively;
a holder for holding the light sensors to allow the light sensors to correspond in position to the indicators on the electronic product, respectively; and
a signal processing module connected to the light sensors for receiving the light testing signals from the light sensors and generating brightness testing signals of the indicators based on the light testing signals, respectively.

2. The indicator testing system of claim 1, wherein the light sensors each comprise:
a light-sensing element for sensing the optical signals and generating the light testing signals based on the optical signals, respectively;
a mask enclosing the light-sensing element, extending forward, and enclosing a light path between the light-sensing element and a corresponding one of the indicators; and
a casing coupled to the light-sensing element and the mask and coupled to the holder.

3. The indicator testing system of claim 2, wherein the casing is externally provided with a thread for engaging with the holder.

4. The indicator testing system of claim 1, further comprising:
a control unit connected to the signal processing module for receiving the brightness testing signals and determining whether the indicators are normal based on the brightness testing signals, respectively.

5. The indicator testing system of claim 1, further comprising:
a control unit connected to the signal processing module for receiving the brightness testing signals and determining an operation status of the electronic product based on sequence of the brightness testing signals or duration of the brightness testing signals.
